(19) United States
(12) Patent Application Publication
(10) Pub. No.: US 2026/0133918 A1
(43) Pub. Date: May 14, 2026

(54) USING UNASSIGNED ADDRESS CYCLE BITS FOR A MULTI-PLANE PAGE READ IN A MEMORY SYSTEM

(71) Applicant: Micron Technology, Inc., Boise, ID (US)

(72) Inventors: Sriram Viswanathan, Hyderabad (IN); Aswath Prabhakar, Hyderabad (IN)

(21) Appl. No.: 19/375,030

(22) Filed: Oct. 30, 2025

Related U.S. Application Data
(60) Provisional application No. 63/719,023, filed on Nov. 11, 2024.

(51) Int. Cl. G06F 13/16; G06F 12/02; G06F 12/0868

(52) U.S. Cl. CPC G06F 13/1689; G06F 12/0246; G06F 12/0868

(57) ABSTRACT

Methods, systems, and devices for using unassigned address cycle bits for a multi-plane page read in a memory system are described. The described techniques may enable a controller to indicate, via an address cycle command of multiple address cycle commands, that one or more read commands and the multiple address cycle commands are for a stripe multi-plane page (e.g., for a same block and page address across multiple planes of a memory device). For example, an address cycle command may include one or more reserved bits that indicate for the memory device to read the data at a block address and a page address from multiple planes. Accordingly, the memory device may retrieve the data of the stripe multi-plane page without receiving separate commands for each plane of the memory device.

### CROSS REFERENCE

The present Application for Patent claims priority to U.S. Patent Application No. 63/719,023 by Viswanathan et al., entitled “USING UNASSIGNED ADDRESS CYCLE BITS FOR A MULTI-PLANE PAGE READ IN A MEMORY SYSTEM,” filed November 11, 2024, which is assigned to the assignee hereof, and which is expressly incorporated by reference in its entirety herein.

### TECHNICAL FIELD

The following relates to one or more systems for memory, including using unassigned address cycle bits for a multi-plane page read in a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports using unassigned address cycle bits for a multi-plane page read in a memory system in accordance with examples as disclosed herein.

FIG. 2 shows an example of an architecture that supports using unassigned address cycle bits for a multi-plane page read in a memory system in accordance with examples as disclosed herein.

FIG. 3 shows an example of an address cycle command diagram that supports using unassigned address cycle bits for a multi-plane page read in a memory system in accordance with examples as disclosed herein.

FIG. 4 shows a block diagram of a memory system that supports using unassigned address cycle bits for a multi-plane page read in a memory system in accordance with examples as disclosed herein.

FIG. 5 shows a flowchart illustrating a method or methods that support using unassigned address cycle bits for a multi-plane page read in a memory system in accordance with examples as disclosed herein.

### DETAILED DESCRIPTION

A memory system may receive a read command for data stored on a stripe multi-plane page (e.g., a super-page). For example, the stripe multi-plane page may include data stored in a same block address and a same page address across multiple planes of the memory system. Such a read command for data across multiple planes may be referred to as a multi-plane read command herein. To execute the multi-plane read command, a controller of the memory system may issue read commands for each plane of the stripe multi-plane page. For example, the controller may issue, to one or more memory devices within the memory system, one or more read commands. Each read command may be for a respective plane and may be accompanied by multiple (e.g., six or seven) address cycle commands that indicate an address for the respective plane of the stripe multi-plane page. Issuing such a large quantity of commands may increase latency associated with reading data from the stripe multi-plane page.

Accordingly, techniques described herein may enable the controller to issue a single read command and a corresponding single set of multiple address cycle commands to each of the planes addressed by a multi-plane read at once, where the controller may indicate, via an address cycle command of the single set of multiple address cycle commands, that the one or more read commands and the multiple address cycle commands are for a stripe multi-plane page (e.g., for multiple planes of the memory system). For example, an address cycle command may include one or more reserved bits (e.g., a plane increment bit) that indicate for the memory device to read the data at a same block address and a same page address (e.g., a block address and page address indicated via the one or more read commands and/or the multiple address cycle commands) within multiple planes (e.g., each plane within the memory device). Accordingly, the memory device may retrieve the data stored at the indicated block and page address on the stripe multi-plane page without receiving separate commands for each plane of the memory device, which may reduce overhead and latency, thereby improving throughput and performance of the memory system for multi-plane reads, among other examples.

In addition to applicability in memory systems as described herein, techniques for indicating that one or more commands are associated with data stored across multiple planes may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds by, for example, reducing a quantity of commands to be issued for multi-plane reads, which may improve response times, or otherwise improve user experience, among other benefits.

Features of the disclosure are illustrated and described in the context of systems, devices, and circuits. Features of the disclosure are further illustrated and described in the context of architectures, address cycle command diagrams, and flowcharts.

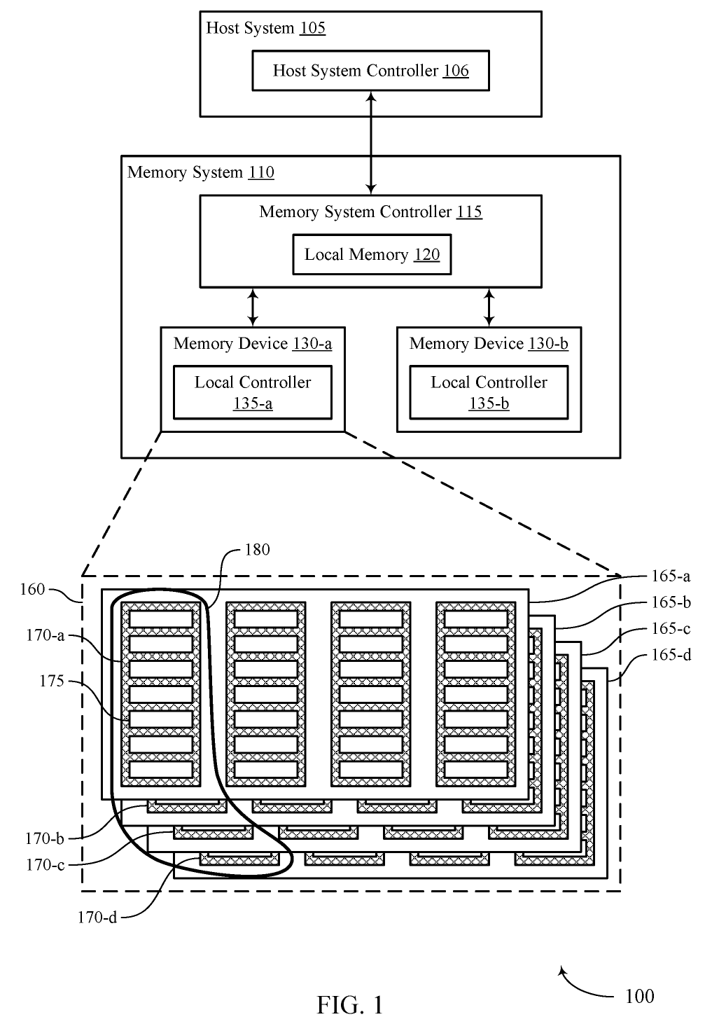

FIG. 1 shows an example of a system 100 that supports using unassigned address cycle bits for a multi-plane page read in a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some examples of the system 100, a controller (e.g., a memory system controller 115) may indicate, via an address cycle command, that one or more read commands and multiple address cycle commands are for a stripe multi-plane page (e.g., for a same block address and page address of multiple planes 165 of a memory system 110). For example, an address cycle command may include one or more reserved bits (e.g., a plane increment bit) that indicate for a memory device 130 to read the data at a block address and page address (e.g., a block address of a block 170 and a page address of one or more pages 175 indicated via the one or more read commands and/or the multiple address cycle commands) from multiple planes 165 (e.g., simultaneously). Accordingly, the memory device 130 may retrieve the data of the stripe multi-plane page without receiving separate commands for each plane of the memory device.

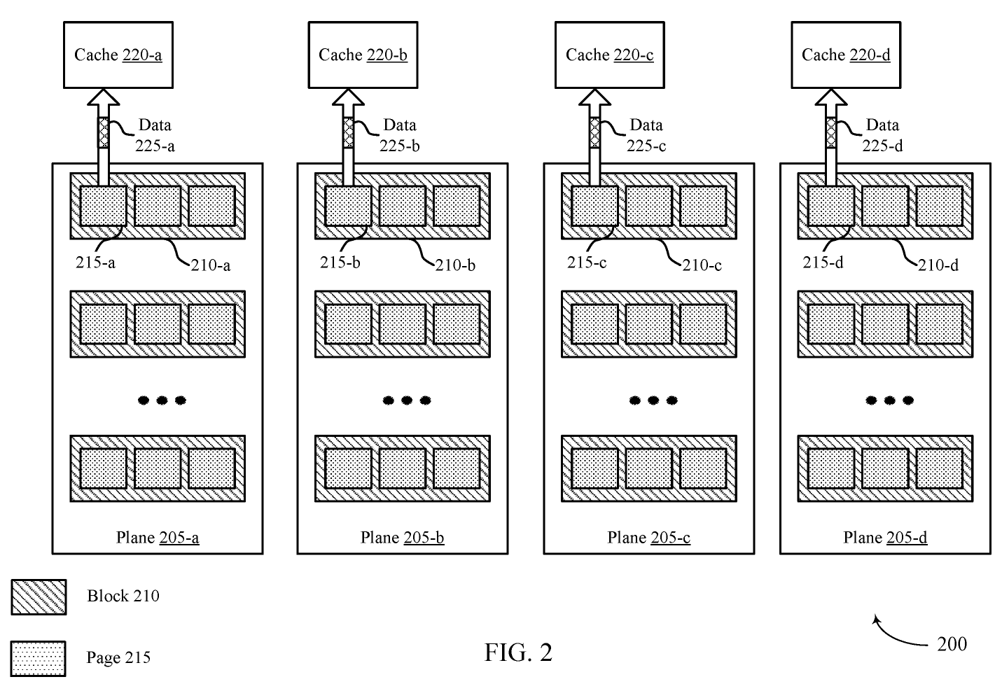

FIG. 2 shows an example of an architecture 200 that supports using unassigned address cycle bits for a multi-plane page read in a memory system in accordance with examples as disclosed herein. The architecture 200 may implement or may be implemented by aspects of the system 100. For example, the architecture 200 may be implemented by (e.g., may represent at least a portion of) a memory system 110, which may be an example of a memory system 110 as described with reference to FIG. 1.

In some examples of the architecture 200, a memory device (e.g., a NAND device) of a memory system may include one or more planes 205 (e.g., a plane 205-a, a plane 205-b, a plane 205-c, and a plane 205-d). The planes 205 may represent examples of the planes 165 as illustrated and described with reference to FIG. 1. Each plane 205 may include one or more blocks 210, and each block 210 may include one or more pages 215, which may represent examples of the blocks 170 and pages 175 described and illustrated with reference to FIG. 1. For example, data may be stored on a page 215 that may be identified according to a block address and a page address associated with a respective plane 205.

In some examples, data stored by the memory device may be stored on a stripe multi-plane page (e.g., a super-page). As described herein, data stored in a stripe multi-plane page may refer to data stored at a same block address (e.g., an address of a given block 210 within a plane 205, such as a common block address of a block 210-a, a block 210-b, a block 210-c, and a block 210-d in FIG. 2) and a same page address (e.g., an address of a given page within the indicated block 210, such as a common page address of a page 215-a, a page 215-b, a page 215-c, and a page 215-d in FIG. 2) across multiple planes 205 (e.g., all planes of the memory device, such as a quad stripe multi-plane page of four planes 205 in FIG. 2, or a hex stripe multi-plane page of six planes 205).

In such examples, a memory controller (e.g., a local controller 135 of the memory device, a memory system controller 115) may issue one or more commands to perform a multi-page read (e.g., to read data stored on a stripe multi-plane page). For example, the memory controller may issue one or more read commands (e.g., 00h, 32h, 30h) and one or more address cycle commands (e.g., six to seven address cycle commands) to the plane 205-a, and may wait for a duration (e.g., tDBSY) for the commands to be read and processed before issuing the one or more read commands and the one or more address cycle commands to the plane 205-b. The memory controller may repeat such a command issue process for each plane 205 of the stripe multi-plane page. In response to each set of commands, the data 225 of the corresponding plane within the stripe multi-plane page (e.g., data 225-a stored on the plane 205-a, data 225-b stored on the plane 205-b, data 225-c stored on the plane 205-c, and data 225-d stored on the plane 205-d) may be read from the memory device and transferred to be stored in caches 220 corresponding to each plane 205, such as a cache 220-a, a cache 220-b, a cache 220-c, and a cache 220-d (e.g., software defined caches (SDCs), data cache latches) associated with temporary storage of data stored on each respective plane 205. The memory controller may issue one or more read commands and/or address cycle commands to retrieve the data 225 stored in each cache 220 (e.g., during a read latency duration tR). The total wait time for a four-plane read may, therefore be around three tDBSY durations (e.g., one after each of the first three commands) and one tR duration after a final command, along with additional processing times.

However, such a process may result in latency associated with retrieving data from a stripe multi-plane page. For example, the memory controller may issue the one or more read commands and the one or more address cycle commands separately for each plane 205, which may increase latency associated with data retrieval and may increase overhead and processing by the memory controller, among other examples.

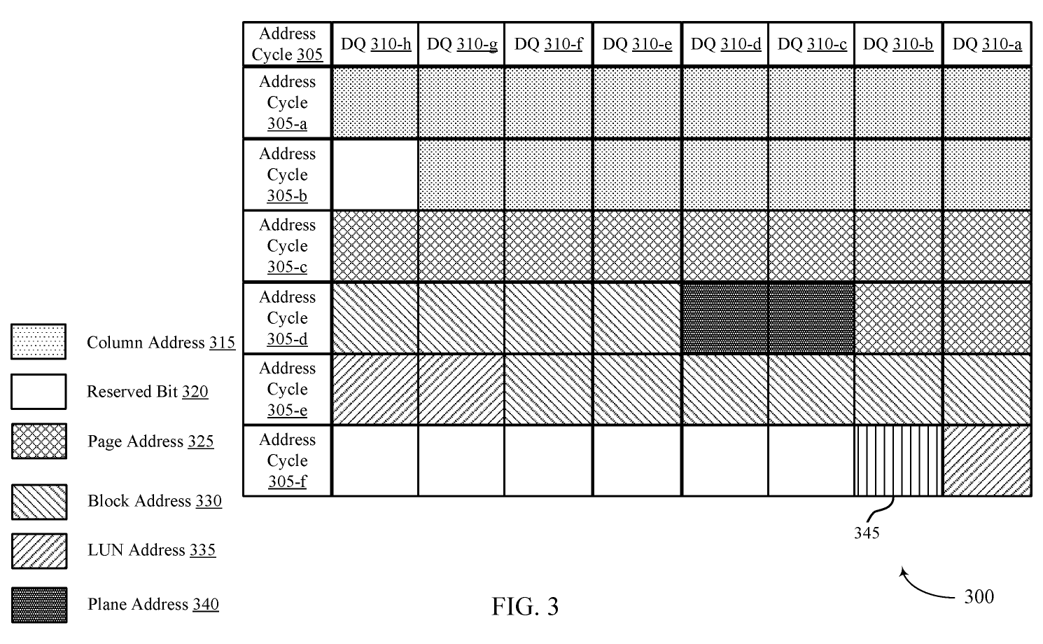

Accordingly, techniques described herein may enable a memory controller to indicate, via one or more bits (e.g., plane increment bits) of an address cycle command, that a set of commands is for data 225 stored in a stripe multi-plane page. The memory device may accordingly apply the set of commands to data in each plane 205 associated with the stripe multi-plane page (e.g., simultaneously or in at least partially overlapping time periods), which may enable the memory controller to perform the multi-page read without issuing separate commands for each plane 205, thereby reducing latency and overhead as compared with systems in which each plane 205 is addressed via separate sets of commands. An address cycle command including such plane increment bits is described in further detail with reference to FIG. 3.

In some examples, to perform such a multi-plane read, the memory controller may issue one or more read commands (e.g., 00h, 30h) and one or more address cycle commands (e.g., six to seven address cycle commands) to the memory device. The one or more address cycle commands may include bits that indicate at least a page address and a block address associated with data, as well as the one or more bits that indicate that the one or more read commands and the one or more address cycle commands are for multiple planes 205 of the memory device (e.g., one or more plane increment bits). During a read latency duration tR, the memory device may store the data 225 of the stripe multi-plane page in the respective caches 220 (e.g., simultaneously or during at least partially overlapping time periods in response to receiving the one or more read commands and one or more address cycle commands that include the one or more plane increment bits). That is, the memory device may retrieve the data 225 from the indicated page address and the indicated block address within each plane 205 of the multiple planes 205 within the memory device. The data 225 from each plane 205 may be transferred to a respective cache 220.

In some examples, the memory controller may initiate a timer (e.g., a single timer) that may last for the duration tR, which may be a duration associated with the transfer of the data 225 from the planes 205 to the caches 220. The memory controller may refrain from initiating one or more timers for durations tDBSY (e.g., in response to indicating that the one or more read commands and the one or more address cycle commands are for multiple planes 205 of the memory device), as only a single set of commands will be issued. The overall delay time for such an operation may thereby be reduced relative to the duration associated with issuing separate sets of commands to each plane 205 and waiting the tDBSY duration between each set of commands. In response to expiration of the timer (e.g., after the read latency duration tR), the memory controller may issue one or more additional read commands (e.g., 06h, E0h) and one or more additional address cycle commands to retrieve (e.g., toggle) the data 225 from the respective caches 220 to another memory location (e.g., to the memory system controller 115, a data buffer, or some other location for sending to the host system 105, for example). The memory controller may accordingly perform the multi-plane read with relatively less latency as compared to multi-plane read commands that do not include the one or more plane increment bits. In some examples, the duration tR of the timer (e.g., the duration between the one or more read command and the one or more additional read commands) may be based on the one or more read commands being for data stored on the stripe multi-plane page (e.g., based on the one or more read commands triggering and the one or more address cycle commands triggering a multi-plane read).

FIG. 3 shows an example of an address cycle command diagram 300 that supports using unassigned address cycle bits for a multi-plane page read in a memory system in accordance with examples as disclosed herein. The address cycle command diagram 300 may implement or may be implemented by aspects of the system 100 or the architecture 200. For example, the address cycle command diagram 300 may be implemented by memory system 110, which may be an example of a memory system 110 as described with reference to FIG. 1.

As described with reference to FIG. 2, to perform a multi-plane read for data stored in a stripe multi-plane page (e.g., a super-page) of a memory device (e.g., data stored at a common block address and page address of one or more planes of the memory device), a memory controller may issue one or more (e.g., six to seven) address cycle commands 305 (e.g., an address cycle command 305-a, an address cycle command 305-b, an address cycle command 305-c, an address cycle command 305-d, an address cycle command 305-e, and an address cycle command 305-f). Each address cycle command 305 may include one or more bits that may be issued to a respective data pin (e.g., DQ pin 310) of the memory device (e.g., a DQ pin 310-a, a DQ pin 310-b, a DQ pin 310-c, a DQ pin 310-d, a DQ pin 310-e, a DQ pin 310-f, a DQ pin 310-g, and a DQ pin 310-h) at a respective time associated with the address cycle command 305.

In some examples, one or more of the address cycle commands 305 may include one or more column address bits 315, one or more reserved bits 320, one or more page address bits 325, one or more block address bits 330, one or more logical unit number (LUN) address bits 335 (e.g., indicating an address of a LUN, which may refer to a NAND die in a multi-die package (MDP)), and/or one or more plane address bits 340 (e.g., bits that may indicate a plane in which the data is stored). The various address bits may indicate an address of data within the memory system that is to be read in accordance with one or more previous read commands issued to the memory system.

In some implementations, to indicate that the one or more address cycle commands 305 and one or more read commands are for the multi-page read, an address cycle command 305 of the one or more address cycle commands 305 (e.g., the address cycle command 305-f) may include at least one plane increment bit 345. The plane increment bit 345 may indicate for the memory device to adjust (e.g., increment) the value indicated via the plane address bits 340 for each plane in the memory device. For example, the plane increment bit 345 may indicate that the one or more read commands and the one or more address cycle commands 305 may apply for an indicated block address and page address for each plane of the stripe multi-plane page (e.g., a block address indicated via the block address bits 330 and a page address indicated via the page address bits 325 of the address cycle commands 305). In some examples, when the address cycle commands 305 are for a multi-plane read, the plane address bits 340 may indicate a default plane address, which may be an address of a first plane in the memory device, or some other default plane. If the plane increment bit 345 is set (e.g., to 1), the memory device may know to apply the read command to each plane within the memory system (e.g., by cycling through the plane addresses, for example).

In some implementations, the plane increment bit 345 may be indicated via a reserved bit 320 that is repurposed (e.g., a reserved bit 320 of the address cycle command 305-f or another address cycle command 305). For example, one or more reserved bits 320 of the address cycle commands 305 may be low (e.g., with a value of 0). The reserved bit 320 used for the plane increment bit 345 may be set to a first value (e.g., 1), which may indicate that the one or more read commands and the one or more address cycle commands 305 may apply to each plane of the stripe multi-plane page. In some examples, a second value of the plane increment bit 345 (e.g., 0) may indicate that the one or more read commands and the address cycle commands 305 are for a single-plane read (e.g., at the plane indicated via the plane address bits 340).

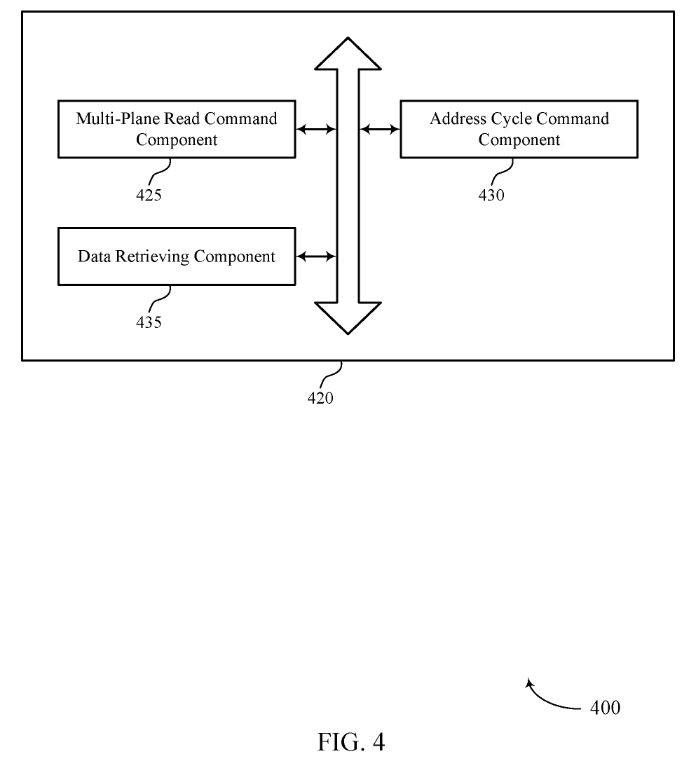

FIG. 4 shows a block diagram 400 of a memory system 420 that supports using unassigned address cycle bits for a multi-plane page read in a memory system in accordance with examples as disclosed herein. The memory system 420 may be an example of aspects of a memory system as described with reference to FIGS. 1 through 3 . The memory system 420, or various components thereof, may be an example of means for performing various aspects of using unassigned address cycle bits for a multi-plane page read in a memory system as described herein. For example, the memory system 420 may include a multi-plane read command component 425, an address cycle command component 430, a data retrieving component 435, or any combination thereof. Each of these components, or components of subcomponents thereof (e.g., one or more processors, one or more memories), may communicate, directly or indirectly, with one another (e.g., via one or more buses).

The multi-plane read command component 425 may be configured as or otherwise support a means for issuing a read command that triggers a multi-plane read operation, where the multi-plane read operation requests a read of data stored within a plurality of planes of a memory system. The address cycle command component 430 may be configured as or otherwise support a means for issuing, based at least in part on the read command, one or more address cycle commands that indicate a page address and a block address, where at least one address cycle command of the one or more address cycle commands includes an indication that the data to be read is stored at the page address and the block address within each plane of the plurality of planes of the memory system. The data retrieving component 435 may be configured as or otherwise support a means for retrieving the data from the plurality of planes based at least in part on the read command and the one or more address cycle commands.

In some examples, to support issuing the one or more address cycle commands, the address cycle command component 430 may be configured as or otherwise support a means for issuing, via the one or more address cycle commands, a first plane address for a first plane of the plurality of planes, the first plane address based at least in part on the multi-plane read operation.

In some examples, to support issuing the one or more address cycle commands, the address cycle command component 430 may be configured as or otherwise support a means for issuing, via the at least one address cycle command, one or more bits set to a first value associated with multi-plane reads, where the indication includes the one or more bits set to the first value.

In some examples, one or more second values of the one or more bits are associated with single-plane reads. In some examples, the one or more second values indicate that the read command and the one or more address cycle commands are associated with one plane of the plurality of planes of the memory system.

In some examples, to support issuing the one or more address cycle commands, the address cycle command component 430 may be configured as or otherwise support a means for issuing, via the at least one address cycle command of the one or more address cycle commands, the indication for the memory system to read the data from each plane of the plurality of planes of the memory system.

In some examples, to support retrieving the data from the plurality of planes, the data retrieving component 435 may be configured as or otherwise support a means for moving, during a first read duration based at least in part on the read command and the one or more address cycle commands, the data from the plurality of planes to a plurality of caches associated with the memory system, where each plane of the plurality of planes is associated with a respective cache of the plurality of caches for temporary storage of respective data associated with each plane.

In some examples, the data retrieving component 435 may be configured as or otherwise support a means for initiating a single timer in response to issuing the one or more address cycle commands. In some examples, the data retrieving component 435 may be configured as or otherwise support a means for issuing, after an expiration of the single timer, one or more second read commands to read the data from the plurality of planes, where moving the data to the plurality of caches is based at least in part on the one or more second read commands, and where a duration between a first command of the one or more address cycle commands and the one or more second read commands is associated with the read command triggering a multi-plane read.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

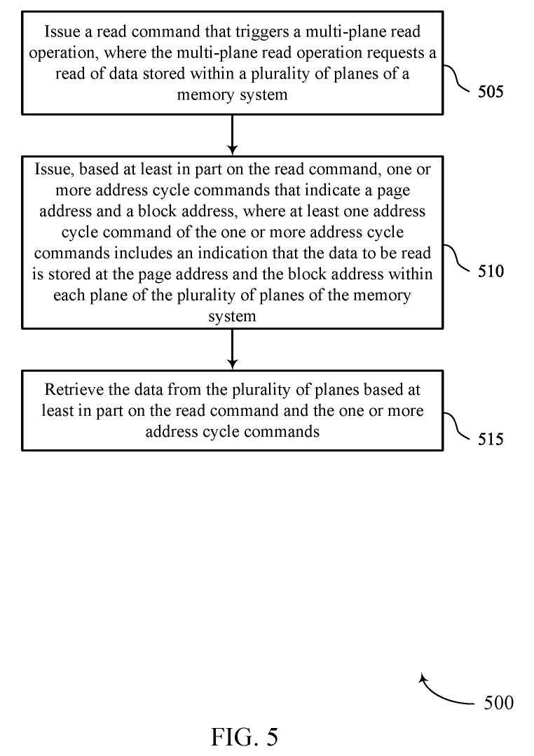

FIG. 5 shows a flowchart illustrating a method 500 that supports using unassigned address cycle bits for a multi-plane page read in a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include issuing a read command that triggers a multi-plane read operation, where the multi-plane read operation requests a read of data stored within a plurality of planes of a memory system. In some examples, aspects of the operations of 505 may be performed by a multi-plane read command component 425 as described with reference to FIG. 4.

At 510, the method may include issuing, based at least in part on the read command, one or more address cycle commands that indicate a page address and a block address, where at least one address cycle command of the one or more address cycle commands includes an indication that the data to be read is stored at the page address and the block address within each plane of the plurality of planes of the memory system. In some examples, aspects of the operations of 510 may be performed by an address cycle command component 430 as described with reference to FIG. 4.

At 515, the method may include retrieving the data from the plurality of planes based at least in part on the read command and the one or more address cycle commands. In some examples, aspects of the operations of 515 may be performed by a data retrieving component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for issuing a read command that triggers a multi-plane read operation, where the multi-plane read operation requests a read of data stored within a plurality of planes of a memory system; issuing, based at least in part on the read command, one or more address cycle commands that indicate a page address and a block address, where at least one address cycle command of the one or more address cycle commands includes an indication that the data to be read is stored at the page address and the block address within each plane of the plurality of planes of the memory system; and retrieving the data from the plurality of planes based at least in part on the read command and the one or more address cycle commands.

Aspect 2: The method, apparatus, or non-transitory computer-readable medium of aspect 1, where issuing the one or more address cycle commands includes operations, features, circuitry, logic, means, or instructions, or any combination thereof for issuing, via the one or more address cycle commands, a first plane address for a first plane of the plurality of planes, the first plane address based at least in part on the multi-plane read operation.

Aspect 3: The method, apparatus, or non-transitory computer-readable medium of any of aspects 1 through 2, where issuing the one or more address cycle commands includes operations, features, circuitry, logic, means, or instructions, or any combination thereof for issuing, via the at least one address cycle command, one or more bits set to a first value associated with multi-plane reads, where the indication includes the one or more bits set to the first value.

Aspect 4: The method, apparatus, or non-transitory computer-readable medium of aspect 3, where one or more second values of the one or more bits are associated with single-plane reads and the one or more second values indicate that the read command and the one or more address cycle commands are associated with one plane of the plurality of planes of the memory system.

Aspect 5: The method, apparatus, or non-transitory computer-readable medium of any of aspects 1 through 4, where issuing the one or more address cycle commands includes operations, features, circuitry, logic, means, or instructions, or any combination thereof for issuing, via the at least one address cycle command of the one or more address cycle commands, the indication for the memory system to read the data from each plane of the plurality of planes of the memory system.

Aspect 6: The method, apparatus, or non-transitory computer-readable medium of any of aspects 1 through 5, where retrieving the data from the plurality of planes includes operations, features, circuitry, logic, means, or instructions, or any combination thereof for moving, during a first read duration based at least in part on the read command and the one or more address cycle commands, the data from the plurality of planes to a plurality of caches associated with the memory system, where each plane of the plurality of planes is associated with a respective cache of the plurality of caches for temporary storage of respective data associated with each plane.

Aspect 7: The method, apparatus, or non-transitory computer-readable medium of aspect 6, further including operations, features, circuitry, logic, means, or instructions, or any combination thereof for initiating a single timer in response to issuing the one or more address cycle commands and issuing, after an expiration of the single timer, one or more second read commands to read the data from the plurality of planes, where moving the data to the plurality of caches is based at least in part on the one or more second read commands, and where a duration between a first command of the one or more address cycle commands and the one or more second read commands is associated with the read command triggering a multi-plane read.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor’s threshold voltage is applied to the transistor gate. The transistor may be “off” or “deactivated” if a voltage less than the transistor’s threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
issue a read command that triggers a multi-plane read operation, wherein the multi-plane read operation requests a read of data stored within a plurality of planes of the memory system;
issue, based at least in part on the read command, one or more address cycle commands that indicate a page address and a block address, wherein at least one address cycle command of the one or more address cycle commands comprises an indication that the data to be read is stored at the page address and the block address within each plane of the plurality of planes of the memory system; and
retrieve the data from the plurality of planes based at least in part on the read command and the one or more address cycle commands.

2. The memory system of claim 1, wherein, to issue the one or more address cycle commands, the processing circuitry is further configured to cause the memory system to:
issue, via the one or more address cycle commands, a first plane address for a first plane of the plurality of planes, the first plane address based at least in part on the multi-plane read operation.

3. The memory system of claim 1, wherein, to issue the one or more address cycle commands, the processing circuitry is further configured to cause the memory system to:
issue, via the at least one address cycle command, one or more bits set to a first value associated with multi-plane reads, wherein the indication comprises the one or more bits set to the first value.

4. The memory system of claim 3, wherein one or more second values of the one or more bits are associated with single-plane reads, and the one or more second values indicate that the read command and the one or more address cycle commands are associated with one plane of the plurality of planes of the memory system.

5. The memory system of claim 1, wherein, to issue the one or more address cycle commands, the processing circuitry is further configured to cause the memory system to:
issue, via the at least one address cycle command of the one or more address cycle commands, the indication for the memory system to read the data from each plane of the plurality of planes of the memory system.

6. The memory system of claim 1, wherein, to retrieve the data from the plurality of planes, the processing circuitry is further configured to cause the memory system to:
move, during a first read duration based at least in part on the read command and the one or more address cycle commands, the data from the plurality of planes to a plurality of caches associated with the memory system, wherein each plane of the plurality of planes is associated with a respective cache of the plurality of caches for temporary storage of respective data associated with each plane.

7. The memory system of claim 6, wherein the processing circuitry is further configured to cause the memory system to:
initiate a single timer in response to issuing the one or more address cycle commands; and
issue, after an expiration of the single timer, one or more second read commands to read the data from the plurality of planes, wherein moving the data to the plurality of caches is based at least in part on the one or more second read commands, and wherein a duration between a first command of the one or more address cycle commands and the one or more second read commands is associated with the read command triggering a multi-plane read.

8. A method, comprising:
issuing a read command that triggers a multi-plane read operation, wherein the multi-plane read operation requests a read of data stored within a plurality of planes of a memory system;
issuing, based at least in part on the read command, one or more address cycle commands that indicate a page address and a block address, wherein at least one address cycle command of the one or more address cycle commands comprises an indication that the data to be read is stored at the page address and the block address within each plane of the plurality of planes of the memory system; and
retrieving the data from the plurality of planes based at least in part on the read command and the one or more address cycle commands.

9. The method of claim 8, wherein issuing the one or more address cycle commands comprises:
issuing, via the one or more address cycle commands, a first plane address for a first plane of the plurality of planes, the first plane address based at least in part on the multi-plane read operation.

10. The method of claim 8, wherein issuing the one or more address cycle commands comprises:
issuing, via the at least one address cycle command, one or more bits set to a first value associated with multi-plane reads, wherein the indication comprises the one or more bits set to the first value.

11. The method of claim 10, wherein one or more second values of the one or more bits are associated with single-plane reads, and wherein the one or more second values indicate that the read command and the one or more address cycle commands are associated with one plane of the plurality of planes of the memory system.

12. The method of claim 8, wherein issuing the one or more address cycle commands comprises:
issuing, via the at least one address cycle command of the one or more address cycle commands, the indication for the memory system to read the data from each plane of the plurality of planes of the memory system.

13. The method of claim 8, wherein retrieving the data from the plurality of planes comprises:
moving, during a first read duration based at least in part on the read command and the one or more address cycle commands, the data from the plurality of planes to a plurality of caches associated with the memory system, wherein each plane of the plurality of planes is associated with a respective cache of the plurality of caches for temporary storage of respective data associated with each plane.

14. The method of claim 13, further comprising:
initiating a single timer in response to issuing the one or more address cycle commands; and
issuing, after an expiration of the single timer, one or more second read commands to read the data from the plurality of planes, wherein moving the data to the plurality of caches is based at least in part on the one or more second read commands, and wherein a duration between a first command of the one or more address cycle commands and the one or more second read commands is associated with the read command triggering a multi-plane read.

15. A non-transitory computer-readable medium storing code, the code comprising instructions executable by one or more processors to:
issue a read command that triggers a multi-plane read operation, wherein the multi-plane read operation requests a read of data stored within a plurality of planes of a memory system;
issue, based at least in part on the read command, one or more address cycle commands that indicate a page address and a block address, wherein at least one address cycle command of the one or more address cycle commands comprises an indication that the data to be read is stored at the page address and the block address within each plane of the plurality of planes of the memory system; and
retrieve the data from the plurality of planes based at least in part on the read command and the one or more address cycle commands.

16. The non-transitory computer-readable medium of claim 15, wherein the instructions to issue the one or more address cycle commands are executable by the one or more processors to:
issue, via the one or more address cycle commands, a first plane address for a first plane of the plurality of planes, the first plane address based at least in part on the multi-plane read operation.

17. The non-transitory computer-readable medium of claim 15, wherein the instructions to issue the one or more address cycle commands are executable by the one or more processors to:
issue, via the at least one address cycle command, one or more bits set to a first value associated with multi-plane reads, wherein the indication comprises the one or more bits set to the first value.

18. The non-transitory computer-readable medium of claim 17, wherein one or more second values of the one or more bits are associated with single-plane reads, and wherein the one or more second values indicate that the read command and the one or more address cycle commands are associated with one plane of the plurality of planes of the memory system.

19. The non-transitory computer-readable medium of claim 15, wherein the instructions to issue the one or more address cycle commands are executable by the one or more processors to:
issue, via the at least one address cycle command of the one or more address cycle commands, the indication for the memory system to read the data from each plane of the plurality of planes of the memory system.

20. The non-transitory computer-readable medium of claim 15, wherein the instructions to retrieve the data from the plurality of planes are executable by the one or more processors to:
move, during a first read duration based at least in part on the read command and the one or more address cycle commands, the data from the plurality of planes to a plurality of caches associated with the memory system, wherein each plane of the plurality of planes is associated with a respective cache of the plurality of caches for temporary storage of respective data associated with each plane.

21. The non-transitory computer-readable medium of claim 20, wherein the instructions are further executable by the one or more processors to:
initiate a single timer in response to issuing the one or more address cycle commands; and
issue, after an expiration of the single timer, one or more second read commands to read the data from the plurality of planes, wherein moving the data to the plurality of caches is based at least in part on the one or more second read commands, and wherein a duration between a first command of the one or more address cycle commands and the one or more second read commands is associated with the read command triggering a multi-plane read.
